(19) United States
(12) Patent Application Publication
(10) Pub. No.: US 2014/0201917 A1
(43) Pub. Date: Jul. 24, 2014

(54) PEG PAD AND METHOD

(71) Applicants: Michael Neel, Memphis, TN (US); Kenneth Weiss, Memphis, TN (US); Ron Hoffman, Memphis, TN (US)

(72) Inventors: Michael Neel, Memphis, TN (US); Kenneth Weiss, Memphis, TN (US); Ron Hoffman, Memphis, TN (US)

(21) Appl. No.: 14/162,184

(22) Filed: Jan. 23, 2014

Related U.S. Application Data
(60) Provisional application No. 61/755,701, filed on Jan. 23, 2013.

(51) Int. Cl. A61G 13/12

(52) U.S. Cl. CPC A61G 13/126
USPC 5/621; 29/428

(57) ABSTRACT

A peg pad, associated method, and associated arrangement are disclosed. The peg pad is designed to be placed over a peg associated with a surgical table to primarily protect a patient situated on the surgical table. The peg pad has a housing defining a pocket-like opening, or channel, sized to receive and surround the top and lateral sides of a peg associated with a surgical table. The pad is made of a unitary piece of a cushion material.

### CLAIM OF PRIORITY

This application claims priority to and the benefit of Application No. 61/755,701, filed Jan. 23, 2013, which is incorporated herein by reference in its entirety.

### FIELD OF INVENTION

The present invention generally relates to medical apparatus and, more particularly, to a pad for augmenting patient positioning during surgical procedures.

### BACKGROUND OF THE INVENTION

During certain surgeries, such as total hip arthroplasty, hip arthroscopy, and hip fracture surgery, for instance, patients are held in a stable position on a surgical table by a series of “pegs”. These pegs fit into holes on a peg board and are placed against the patient. These are simply metal posts, covered in hard rubber that rests directly against the patient. They, in effect, hold the patient in a fixed position for the entirety of the surgical procedure, which can be several hours. The pegs are often directly engaged against bony prominences. As a result, a patient is at risk for skin damage, pressure ulcers, and nerve compression damage from prolonged contact with the hard rubber of the peg. In an effort to prevent undue compression of the peg against the patient, a protective layer of material is often utilized.

Sometimes, a piece of foam (designed for other padding applications, not specifically for the peg or post) is “sandwiched” between the peg and the patient. Also, there are “gel pads” that can be placed around the pegs or layered between the peg and the patient. Neither of the forgoing attempts at layering completely covers the peg. And, not being designed for use with the peg specifically, do not fit well. Often, these shift and even fall out during the course of the procedure. Additionally, the pegs and gel coverings are multi-use and have to be manually cleaned/sanitized after each use.

### SUMMARY OF THE INVENTION

Various embodiments of a peg pad and associated method are disclosed.

One embodiment, among others, is a peg pad that is designed to be placed over a peg associated with a surgical table to primarily protect a patient situated on the table. The peg pad has a housing defining an elongated pocket-like opening, or channel, sized to receive and surround the top and lateral sides of a peg associated with a surgical table. The pad can be made of a unitary piece of a cushion material. Preferably, cushion material is a flexible foam material that is deformable, but which can rebound to its original state.

Another embodiment, among others, is a method that can broadly be summarized by the following steps: providing a surgical table having a peg; placing a peg pad on the peg, the peg pad comprising a cushion material; and situating a patient on the surgical table so that the patient contacts the peg pad.

Another embodiment, among others, is an arrangement, comprising a surgical table having a peg; peg pad on the peg, the peg pad comprising a housing defining an opening sized to receive and surround the top and lateral sides of the peg associated with the surgical table, the housing made of a cushion material; and a patient on the surgical table so that the patient contacts the peg pad.

Other apparatus, systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a peg pad in accordance with a first embodiment of the present invention.

FIG. 2 is a perspective view, from a top side vantage point, of the peg pad of FIG. 1 with a peg inserted therein.

FIG. 3 is a side view of the peg pad of FIG. 1 with a peg inserted therein.

FIG. 4 is a perspective view of a surgical table with pegs.

FIG. 5 is perspective view of a patient lying upon the surgical table of FIG. 4 with the peg pads of FIG. 1 having pegs inserted therein.

FIG. 6 is a side view of a peg pad in accordance with a second embodiment of the present invention.

FIG. 7 is a perspective view of the peg pad of FIG. 6.

### DETAILED DESCRIPTION OF THE PREFERRED EMBODIMENTS

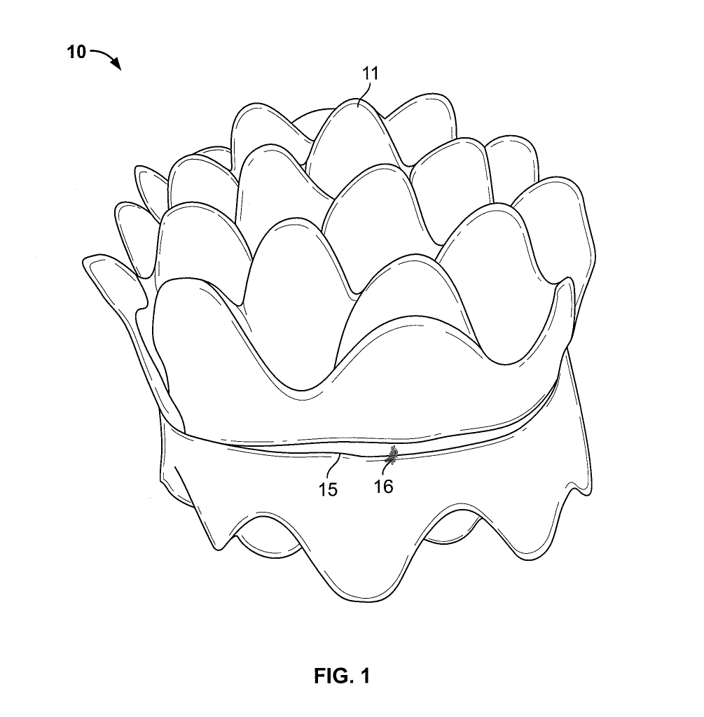

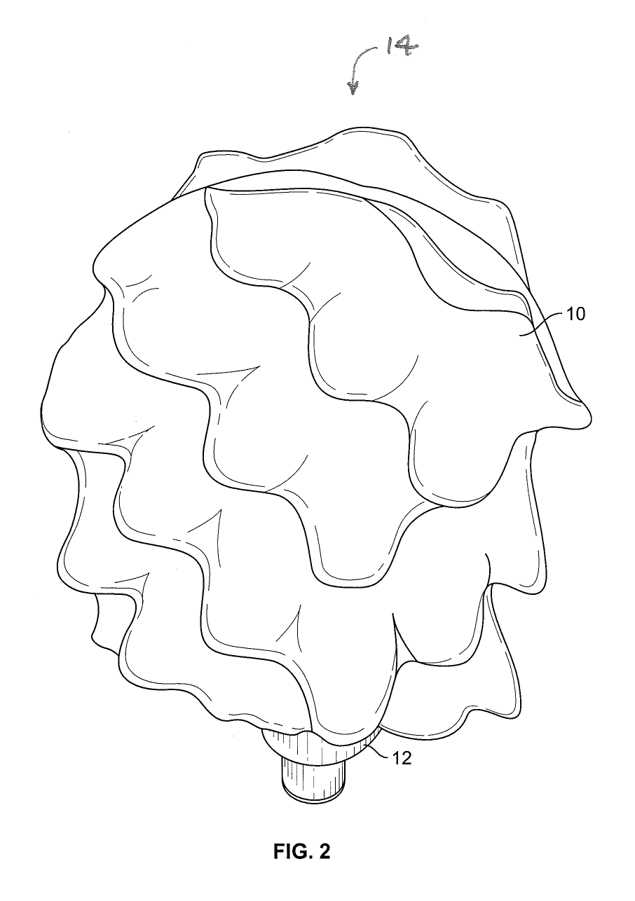

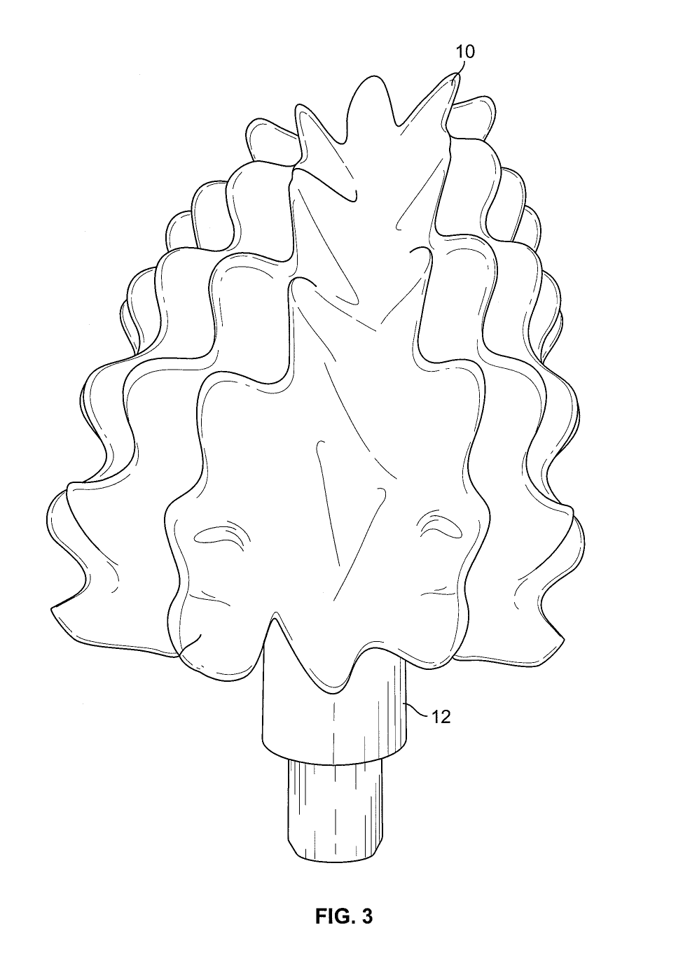

FIGS. 1-3 show a first embodiment of the peg pad, which is generally denoted by reference numeral 10. The peg pad 10 of the first embodiment of the present invention has a body, made from a cushion material, with an opening and a closed end 14, creating an elongated pocket. The cushion material is preferably a material that is deformable, but which can rebound to its original state. The cushion material can be, for example, but not limited to, a soft corrugated foam material with outwardly protruding soft fingers 11 to enhance the cushion effect. The peg pad 10 can also be made as a unitary piece or as a multi-piece apparatus.

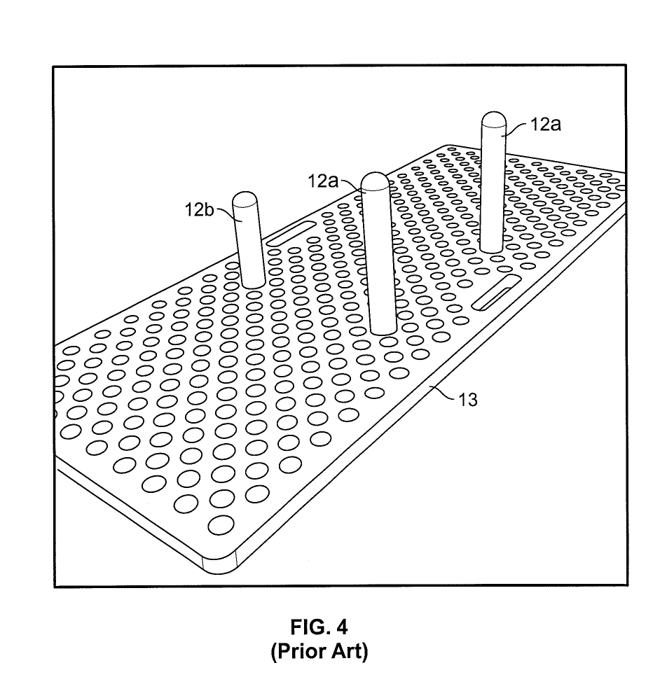

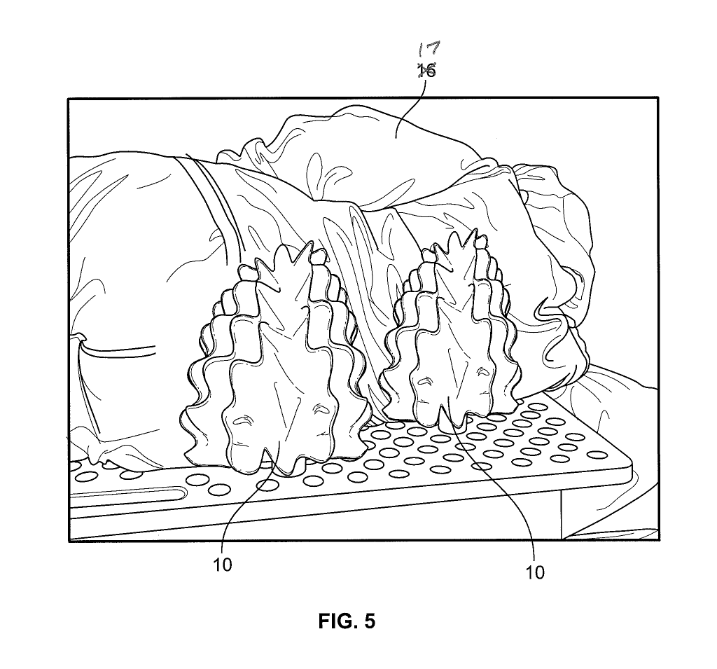

The rubber/metal peg 12 of a surgical table 13 fits, preferably snugly, inside the elongated pocket 16 of the peg pad 10, creating essentially a foam envelope around the peg 10. The edges 15 are separated to create the opening and to place the peg pad 10 over a peg 12. Typically, surgical positioning pegs 12 come in two lengths and two diameters, as shown in FIG. 4, based on patient positioning requirements. The diameter of the opening 16 and the inner depth of the opening 16 are preferably sized to accommodate the various size dimensions of the most commonly used pegs 10.

The peg pad 10 can take various shapes and sizes, and can be designed with many possible materials. The opening 16 can also take different configurations. For instance, it may be cylindrical, conical, etc.

The peg pad 10 serves a twofold purpose. First, the peg pad 10 serves as a patient safety device. The peg pad 10 affords a soft cushion of foam to prevent pressure sores from arising at contact points between the peg 12 and the skin of the patient 17. Second, the peg pad 10, being a single use item, thus provides a more sanitary situation without the need for periodic cleaning of the peg 12.

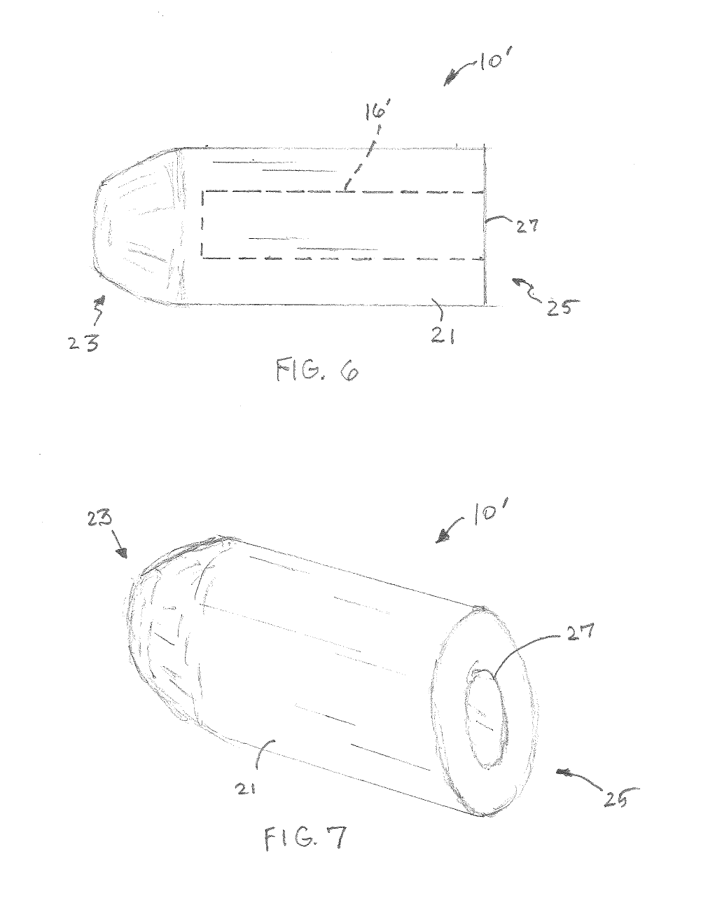

FIGS. 6 and 7 illustrate a second embodiment of the peg pad and is generally denoted by reference numeral 10′. The peg pad 10′ has an elongated cylindrical body 21 with a frustoconical closed end 23 and an opposite end 25 having a circular aperture 27 that lead into an elongated cylindrical opening 16′, or channel. The elongated cylindrical opening 16′ is sized to receive the peg 12, preferably snugly. The depth and diameter of the opening 16′ in the peg pad 10′ can vary, but is preferably designed to accommodate any size of peg 12. The peg pad 10′ is generally made from a cushion material that is deformable, but which can rebound to its original state. As a nonlimiting example, the peg pad 10′ can be made from a flexible foam material, for example but not limited to, 1.2 pound per cubic foot density flexible polyether urethane foam (e.g., 30 ILD). The peg pad 10′ can also be made as a unitary or multi-piece apparatus.

Many other embodiments of the peg pad are possible. For example, another embodiment is a peg pad that is similar to the peg pad 10″, but which has a flat end instead of the frustoconical end 23.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present inventions.

At least the following is claimed:

1. A peg pad, comprising:
a housing defining an elongated opening sized to receive and surround the top and lateral sides of a peg associated with a surgical table; and
wherein the pad is made of a unitary piece of a cushion material.

2. The peg pad of claim 1, wherein the cushion material is a flexible foam.

3. The peg pad of claim 1, further comprising the surgical table having a peg inserted in the peg pad.

4. The peg pad of claim 1, wherein the housing has cylindrical body with first and second ends, the first end being frustoconical in shape and closed, the second end having an aperture, the aperture leading into the opening, the opening being cylindrical in shape.

5. The peg pad of claim 1, wherein the lateral body of the housing is cylindrical in shape and wherein the opening is cylindrical in shape.

6. A method, comprising:
providing a surgical table having a peg; and
placing a peg pad on the peg, the peg pad comprising:
a housing defining an internal channel sized to receive and surround the top and lateral sides of the peg associated with the surgical table, the housing made of a cushion material.

7. The method of claim 6, wherein the cushion material is a flexible foam material that is deformable, but which can rebound to its original state.

8. The method of claim 6, further comprising situating a patient on the surgical table so that the patient contacts the peg pad.

9. The method of claim 6, wherein the housing has cylindrical body with first and second ends, the first end being frustoconical in shape and closed, the second end having an aperture, the aperture leading into the opening, the channel being cylindrical in shape.

10. The method of claim 6, wherein the lateral body of the housing is cylindrical in shape and wherein the channel is cylindrical in shape.

11. An arrangement, comprising:
a surgical table having a peg;
peg pad on the peg, the peg pad comprising a housing defining an opening sized to receive and surround the top and lateral sides of the peg associated with the surgical table, the housing made of a cushion material; and
a patient on the surgical table so that the patient contacts the peg pad.

12. The arrangement of claim 11, wherein the cushion material is a flexible foam.

13. The arrangement of claim 11, wherein the housing has cylindrical body with first and second ends, the first end being frustoconical in shape and closed, the second end having an aperture, the aperture leading into the opening, the opening being cylindrical in shape.

14. The arrangement of claim 11, wherein the housing comprises a cylindrical body and wherein the opening is an elongated cylinder.
